(19) United States
(12) Patent Application Publication
(10) Pub. No.: US 2009/0307602 A1
(43) Pub. Date: Dec. 10, 2009

(54) SYSTEMS AND METHODS FOR CREATING AND SHARING A PRESENTATION

(75) Inventors: Beau Brewer, Salt Lake City, UT (US); Benjamin L. Teerlink, Salt Lake City, UT (US); R. Bret Peterson, Salt Lake City, UT (US); Michael B. Edgington, Herriman, UT (US); Donald Q. Millar, Salt Lake City, UT (US)

Correspondence Address: Workman Nydegger;1000 Eagle Gate Tower, 60 East South Temple, Salt Lake City, UT, 84111, US

(73) Assignee: LIFE IN FOCUS, LLC, Salt Lake City, UT (US)

(21) Appl. No.: 12/478,617

(22) Filed: Jun. 4, 2009

Related U.S. Application Data
(60) Provisional application No. 61/059,747, filed on Jun. 6, 2008.

(51) Int. Cl. G06F 3/01; G06F 17/00; G06F 15/16

(52) U.S. Cl. 715/744; 700/94; 709/203

(57) ABSTRACT

In one example, a method for creating a presentation comprises uploading a plurality of digital medial files from a client device to an application server for processing and subsequent storage on a media server. The method additionally comprises receiving user input from the client device defining aspects of a presentation, the user-defined aspects identifying a configuration file and a plurality of digital media files for inclusion in the presentation. The method further comprises transmitting the user-defined aspects from the client device to the application server. The application server stores a record of the presentation, the record including the user-defined aspects. Further, the application server distributes a link to the record that is accessed to retrieve and dynamically render the presentation.

### CROSS-REFERENCE TO RELATED APPLICATIONS

The present application claims the benefit of and priority to U.S. Provisional Application Ser. No. 61/059,747, entitled “SYSTEMS AND METHODS FOR DISPLAYING A PRESENTATION,” filed Jun. 6, 2008, which application is fully incorporated herein by reference in its entirety.

### BACKGROUND

1. Field of the Invention

The present invention generally relates to content sharing systems. In particular, some example embodiments relate to methods and systems for creating and/or sharing presentations comprising digital media.

2. Related Technology

With the proliferation of digital cameras and other devices for capturing personalized digital media files (e.g., images, audio, video, etc.) in recent years, systems for creating and sharing slideshows made up of digital images and/or other digital media files have become increasingly popular. Some conventional systems merely display multiple digital image files in sequence without any customization.

Other conventional systems allow a user to add an audio component to a sideshow of digital image files to add a customized aspect to the slideshow. However, the audio file and digital image files are combined into a video file such that the digital image files and the audio file always play in parallel. Accordingly, if a user of the slideshow navigates forward or backward in the sequence of digital image files, playback of the audio file will also jump forward or backward. The interruption of the audio file may be irritating to a user who desires to listen to an uninterrupted audio file while simultaneously skipping over images the user is not interested in or returning to images the user desires to view again or that the user missed.

Furthermore, to view a slideshow created by another, a user typically has to retrieve the slideshow and initialize a slideshow application or otherwise actively operate a computer to view the slideshow. In some instances, however, a slideshow creator may desire to share a slideshow with another user who is not technically savvy or who is unable or unwilling to operate a computer to view the slideshow. For instance, a slideshow creator may desire to share a slideshow with a grandparent who lacks computer experience and who is not interested in learning. In this example, any time the slideshow creator wants to share a slideshow with the grandparent, the slideshow creator has to be united with the grandparent and a computer in the same physical location to setup the slideshow on the computer for the grandparent to view. In many cases, the inconvenience and difficulty involved in uniting the slideshow creator with the grandparent and the computer in the same physical location can ultimately result in the slideshow creator not sharing the slideshow with the grandparent at all.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

In general, example embodiments of the invention relate to methods and systems for creating and/or sharing presentations comprising digital media.

In one example embodiment, a method for creating a presentation comprises uploading a plurality of digital medial files from a client device to an application server for processing and subsequent storage on a media server. The method additionally comprises receiving user input from the client device defining aspects of a presentation, the user-defined aspects identifying a configuration file and a plurality of digital media files for inclusion in the presentation. The method further comprises transmitting the user-defined aspects from the client device to the application server. The application server stores a record of the presentation, the record including the user-defined aspects. Further, the application server distributes a link to the record that is accessed to retrieve and dynamically render the presentation.

In another example embodiment, a method for sharing a presentation comprises receiving user input defining aspects of a presentation, the user-defined aspects identifying a configuration file and one or more digital media files to include in the presentation. The method additionally comprises storing a record of the presentation on the application server, the record including the user-defined aspects. The method further comprises distributing a link to the record. The method additionally comprises transmitting the record to a second client device in response to the second client device accessing the link. The second client device retrieves the one or more digital media files using the record and dynamically renders the presentation according to the user-defined aspects.

In yet another example embodiment, a method of rendering a presentation on a client device comprises downloading a configuration file associated with a presentation from an application server, the configuration file including an identifier associated with the presentation. The method additionally comprises downloading a record of the presentation from the application server using the presentation identifier, the record comprising a plurality of user-defined aspects, the plurality of user-defined aspects identifying a plurality of digital media files included in the presentation. The method further comprises downloading the plurality of digital media files from a media server using the user-defined aspects. The method additionally comprises dynamically rendering the presentation according to the user-defined aspects.

In yet another example embodiment, an application server for creating and sharing a presentation comprises a computing device, a memory, an upload application, a media processing module, and a builder application. The computing device is configured to execute computer-executable instructions. The memory is operably connected to the computing device and comprises a tangible computer readable medium. The upload application is stored on the memory and is configured to be transmitted to and executed by a first client device. The upload application comprises computer-executable instructions that, if executed by the first client device, cause the first client device to upload digital media files to the application server. The media processing module is stored on the memory and comprises computer-executable instructions that, if executed by the computing device, cause the computing device to process digital media files received from the first client device. The builder application is stored on the memory and is configured to be transmitted to and executed by the first client device. The builder application comprises computer-executable instructions that, if executed by the first client device, cause the first client device to create a presentation comprising a configuration file and one or more digital media files.

These and other aspects of example embodiments of the invention will become more fully apparent from the following description and appended claims.

### BRIEF DESCRIPTION OF THE DRAWINGS

To further clarify various aspects of some embodiments of the invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 discloses one example operating environment in which embodiments of the invention can be practiced;

FIG. 2 discloses an example application server that can be implemented in the operating environment of FIG. 1;

FIG. 3A discloses an example presentation that can be created and shared in the operating environment of FIG. 1 according to some embodiments of the invention;

FIG. 3B discloses an example configuration file that can be included in the presentation of FIG. 3A;

FIG. 3C discloses an example user interface generated by execution of the configuration file of FIG. 3B;

FIGS. 4A and 4B disclose example upload scripts that can be employed to receive digital media files from a client device;

FIG. 5A discloses an example service file that can be employed at the application server of FIG. 2 according to some embodiments of the invention;

FIGS. 5B and 5C disclose example records that can be employed by the service file of FIG. 5A to communicate with an upload application and/or builder application executing on a client device;

FIG. 6 discloses an example operating process for the operating environment of FIG. 1;

FIG. 7 discloses an example method for uploading digital media from a client device to an application server;

FIG. 8 discloses an example method for creating a presentation;

FIG. 9 discloses an example method for sharing a presentation; and

FIG. 10 discloses an example method for rendering a presentation.

### DETAILED DESCRIPTION OF EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

### I. Operating Environment

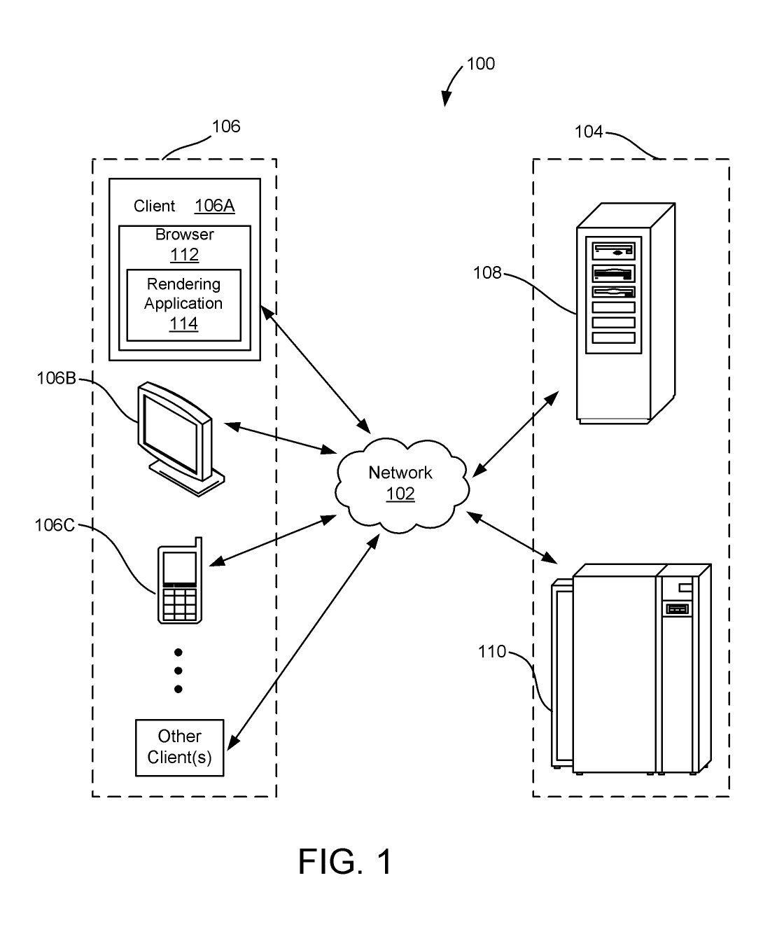

With reference first to FIG. 1, an example operating environment 100 is illustrated in which some embodiments of the invention can be practiced. The example operating environment 100 includes a network 102 used by a content sharing system 104 and one or more client devices 106 to communicate with each other.

The network 102 is illustrated in simplified form and exemplarily includes the Internet, comprising a global internetwork formed by logical, physical and/or wireless connections between multiple wide area networks and/or local area networks. Alternately or additionally, the network 102 includes a satellite network, a cellular RF network and/or one or more wired and/or wireless networks such as, but not limited to, 802.xx networks, Bluetooth access points, wireless access points, IP-based networks, or the like. The network 102 also includes servers that enable one type of network to interface with another type of network.

As shown in FIG. 1, the content sharing system 104 comprises an application server 108 and a media server 110. Briefly, the application server 108 hosts a plurality of applications and modules that allow users of the client devices 106 to create and/or share presentations with each other. As used herein, a presentation refers to a combination of two or more digital media files. Presentations include, for example, slideshows made up of two or more digital image files. Further, digital media files refer to digital text, images, graphics, photographs, video, audio, or other digital media files. The media server 110 stores digital media uploaded by users of the client devices 106 and/or digital media provided by an administrator of the content sharing system 104. Although the servers 108, 110 are disclosed as separate servers in FIG. 1, embodiments of the invention contemplate combining or separating the features and functionality provided by servers 108, 110 into a single server or into three or more servers. Aspects of the application server 108 and media server 110 are described in greater detail below.

Each of client devices 106 comprises means for communicating with the content sharing system 104 via network 102 to send and/or receive digital media to and/or from the content sharing system 104. As such, each of client devices 106 can comprise a laptop or desktop computer (“personal computer”), wireless or mobile telephone, a Personal Digital Assistant (“PDA”), a smartphone, a network-enabled digital picture frame, or any other client device configured to communicate over the network 102. In the example of FIG. 1, client devices 106 include a client device 106A comprising a personal computer, a network-enabled digital picture frame 106B, and a mobile telephone 106C.

Additionally, client device 106A comprises a browser 112 or other application suitable for interacting with web page files hosted by a server, such as the application server 108. By way of example only, the browser 112 may comprise the Internet Explorer web browser developed by Microsoft Corporation, the Safari web browser developed by Apple Inc., or the like.

As shown, client device 106A further comprises a rendering application 114 for rendering digital media, including presentations downloaded from the content sharing system 104. By way of example only, the rendering application 114 may comprise the Microsoft Silverlight web browser plugin developed by Microsoft Corporation, the Adobe Flash Player multimedia player developed by Macromedia and Adobe Systems Incorporated, or the like. Rendering of presentations by the rendering application 114 can include, among other things, visually rendering image or video files and audibly rendering audio files included in the presentations.

Although not shown in FIG. 1, one or more of client devices 106B, 106C or other client devices 106 can additionally comprise one or more of a browser 112 or rendering application 114.

### II. Example Application Server

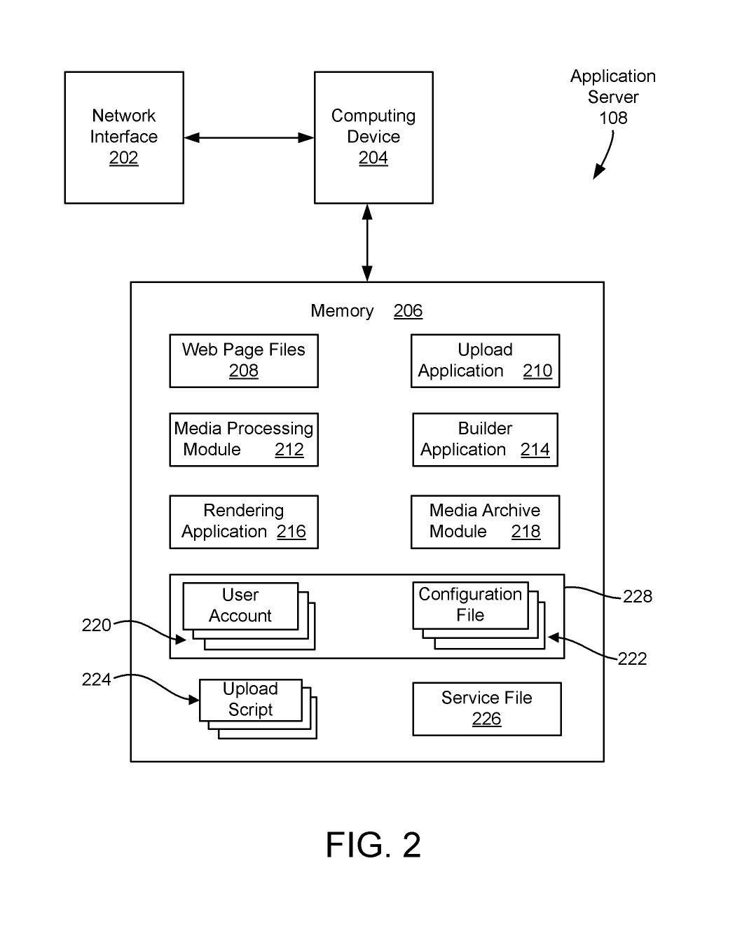

With additional reference to FIG. 2, an example embodiment of the application server 108 is disclosed. As shown in FIG. 2, the application server 108 comprises a network interface 202 for connecting to the network 102 of FIG. 1 and communicating with the client devices 106 and/or media server 110.

The application server 108 further includes a computing device 204 and a memory 206 connected with each other and the network interface 202 via a communication bus or other communication device. The computing device 204 is configured to, among other things, execute computer-executable instructions stored on the memory 206 and to write data to or read data from the memory 206. As such, the computing device 204 may comprise one or more of a processor, controller, or other computing device.

The memory 206 is configured to store data associated with users of the client devices 106 of FIG. 1 and to store computer-executable instructions, that if executed by the computing device 204 or client devices 106, cause the computing device 204 or client devices 106 to perform the processes described herein. As shown in FIG. 2, the memory 206 includes one or more web page files 208, an upload application 210, a media processing module 212, a builder application 214, an optional rendering application 216, an optional media archive module 218, a plurality of user accounts 220, a plurality of configuration files 222, an optional plurality of upload scripts 224 and a service file 226.

The memory 206 can comprise volatile or non-volatile memory, including one or more of flash memory, magnetic disk storage or other magnetic storage devices, CD-ROM or other optical disk storage, random access memory (“RAM”), read only memory (“ROM”), electrically erasable and programmable read only memory (“EEPROM”), or any other physical medium which can be used to carry or store desired program code means in the form of computer-executable instructions or data structures and which can be accessed by a general purpose or special purpose computer.

The web page files 208 stored in memory 206 are configured to be displayed in browsers 112 of the client devices 106 of FIG. 1. In some embodiments, each of web page files 208 comprises, for instance, a hypertext document including one or more embedded hyperlinks that point to other web page files 208 or that call or communicate with one or more of the components 210, 212, 214, 216, 218, 220, 222, 224, 226 of application server 108.

The upload application 210 allows users to upload digital media to the content sharing system 104 via client devices 106. In some embodiments, the upload application 210 comprises a web application such as a rich internet application (“RIA”) or other web application that is accessed via a browser, such as the browser 112 of FIG. 1. For instance, in some embodiments, one or more of web page files 208 comprises a hyperlink/pointer to upload application 210 and a user operates client device 106A of FIG. 1 to execute the browser 112 to interact with web page files 208. While viewing the web page file 208 via browser 112, the user can select a corresponding hyperlink/pointer from the web page file 208 to call the upload application 210, such that the upload application 210 is transmitted to the client device 106A and executed in the browser 112. Accordingly, although the upload application 210 is stored in the memory 206 of application server 108, the upload application 210 can be executed on one or more of client devices 106. Alternately or additionally, the upload application 210 can be stored permanently on one or more of client devices 106.

The media processing module 212 is configured to process digital media uploaded to the application server 108. Generally, processing digital media refers to altering one or more parameters of the digital media, generating modified instances of the digital media, and/or generating metadata associated with the digital media. Depending on the type of digital media (e.g., image, video, audio, etc.), digital media parameters may include one or more of file size, image aspect ratio, image size, image cropping, image color depth, image resolution, file compression, video stream length, audio stream length, or the like. The media processing module 212 can process digital media automatically, in response to user input, or based on one or more predetermined criteria. In some examples, for instance, uploaded images are automatically resized and/or have their color depth altered by the media processing module 212 to satisfy a predetermined size and/or color depth criterion for inclusion in a presentation.

The builder application 214 allows users to create new presentations, modify existing presentations, and/or share presentations with other users. A user that creates or modifies a presentation will be referred to herein as a “creator.” A user designated by a creator to receive a presentation will be referred to herein as a “recipient.” A user can explicitly designate a recipient by identifying the particular recipient or an address associated with the recipient during creation of a slideshow, or the user can implicitly designate a recipient by designating a blog, social networking page or other website to which a link to the presentation is posted, the blog, social networking page or other website being accessible to one or more users that can access the link to receive the presentation.

Furthermore, the terms “creator” and “recipient” are not mutually exclusive; indeed, a user can be a creator, a recipient, both a creator and a recipient, or neither a creator nor a recipient. However, for simplicity in describing embodiments of the invention herein, the term “creator” will typically be used when referring to a user that creates a presentation, the term “recipient” will typically be used when referring to a user that receives a presentation, and the term “user” will typically be used when the distinction between creator and recipient is irrelevant.

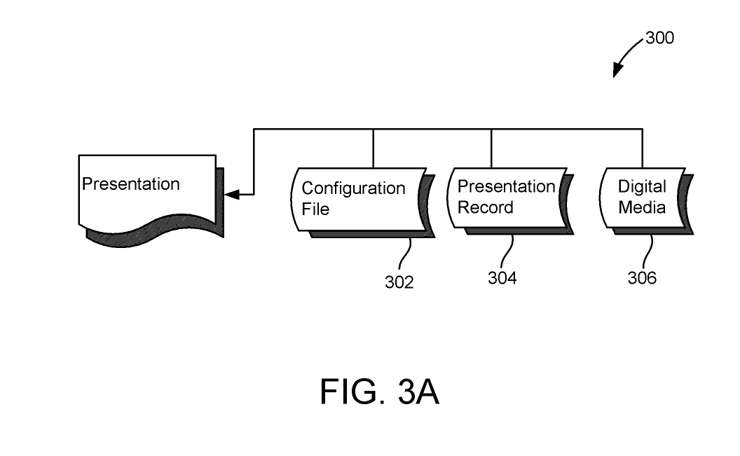

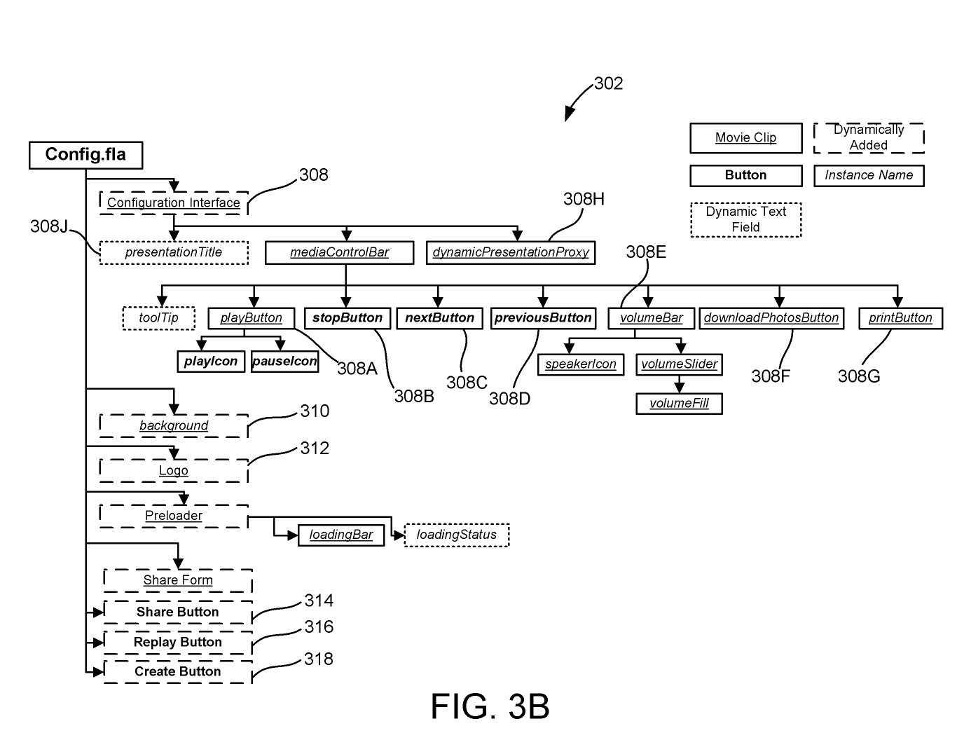

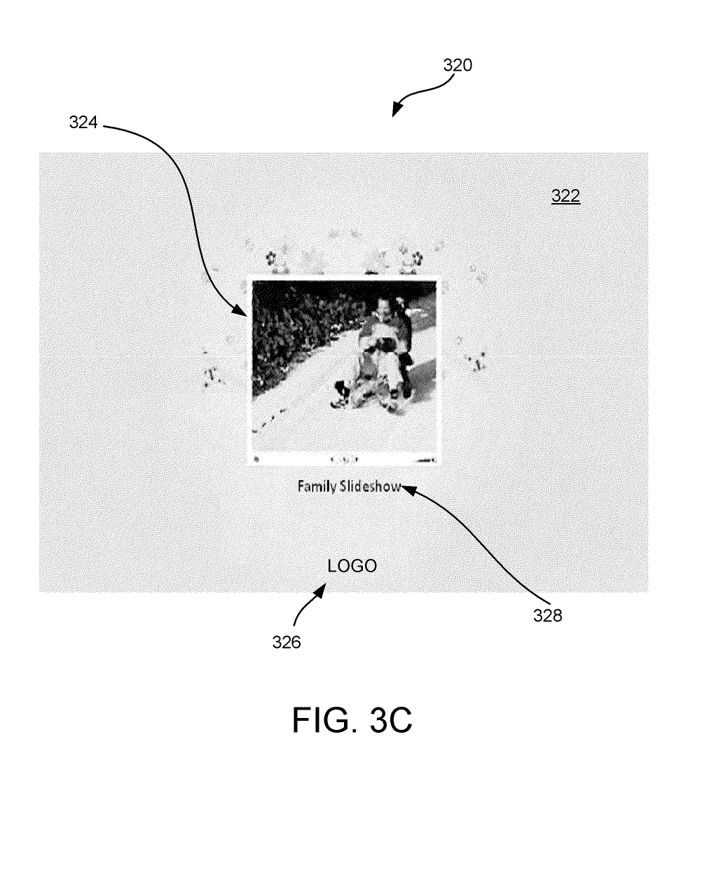

One example of a presentation 300 that can be created or modified using the builder application 214 according to embodiments of the invention is disclosed in FIG. 3A. As shown in FIG. 3A, the presentation 300 comprises a configuration file 302, a presentation record 304, and digital media 306. The configuration file 302 can be selected by a creator from among the configuration files 222 of FIG. 2, described in greater detail below. Briefly, however, the configuration file 302 defines a particular theme or “look and feel” of the presentation 300 and can be executed by a rendering application 114 on a client device 106 to render the presentation 300. The digital media 306 includes the images, music, or other digital media files included in the presentation 300.

The presentation record 304 includes, among other things, an identification of and/or pointers to the particular digital media 306 included in the presentation 300. Alternately or additionally, the presentation record 304 identifies whether certain presentation features are enabled or disabled for the presentation 300. For instance, the presentation record 304 can identify one or more of: whether to display a title of the presentation during rendition of the presentation, whether to allow recipients to share the presentation with other users, whether to allow recipients to download some or all of the digital media 306, whether to allow recipients to print some or all of the digital media 306, or the like. Although not required, in some embodiments, the presentation record 304 comprises a value object (“VO”).

Returning to FIG. 2, the builder application 214 can alternately or additionally be configured to allow a user to organize uploaded digital media into albums, to add associated metadata such as description(s) or tag(s) to uploaded digital media, to add contact information for recipients, and/or to organize contacts into contact groups. Similar to the upload application 210, in some embodiments, the builder application 214 comprises a web application such as an RIA or other web application that is accessed via a browser, such as the browser 112 of FIG. 1. As such, the builder application 214 can be called from a web page file 208 displayed in the browser 112 and subsequently executed in the browser 112. Accordingly, although the builder application 214 is stored in the memory 206 of application server 108, the builder application 214 can be executed on one or more of client devices 106. Alternately or additionally, the builder application 214 can be stored permanently on one or more of client devices 106.

The rendering application 216 can be similar to the rendering application 114 of FIG. 1 and can be made available for download to the client devices 106. Alternately or additionally, the client devices 106 can download rendering applications 114 from other sources.

The media archive module 218 is configured to allow users to retrieve digital media files associated with the users that have been uploaded to the media server 110 through application server 108. For instance, digital media uploaded to the application server 108 can be saved as-is to the media server 110 of FIG. 1. Alternately or additionally, the media processing module 212 can generate processed digital media, such as thumbnails of image files, that is also saved to the media server 110. In this and other examples, the media archive module 218 can retrieve, in response to user request, the original digital media uploaded by the user and/or the processed digital media generated by the media processing module 212.

The user accounts 220 form part of a database 228 stored in memory 206. Each user account 220 stores information associated with a corresponding user. For instance, for a given user, a user account 220 can store one or more of the user's name, billing information such as credit card number, pointers to digital media uploaded by the user, pointers to presentations created by the user, metadata associated with the digital media or presentations, or the like. Each pointer can comprise, for instance, a hash value obtained by applying a hash function to the corresponding digital media or presentation. The metadata associated with the digital media or presentations can comprise, for instance, the pointers to the digital media or presentations and/or a title of the digital media/presentation, a description of the digital media/presentation, a tag associated with the digital media/presentation, or the like.

A. Configuration Files

The configuration files 222 also form part of the database 228 stored in memory 206 and define particular presentation themes or “look and feel.” In more detail, each configuration file 222 defines how to render a presentation according to the corresponding theme. For instance, each configuration file 222 can define a background, layout, appearance, or other aspects of a presentation. Accordingly, each configuration file 222 comprises computer-executable instructions that, if executed by a rendering application such as rendering application 114, cause the rendering application to render a presentation in accordance with the theme defined by the configuration file 222. In some embodiments, each configuration file comprises an .swf file or other file executable by a rendering application 114 on a client device 106.

By way of example, one configuration file 222 may define a “beach” theme, while another configuration file 222 defines a “spring break” theme, and yet another configuration file 222 defines a “wedding” theme, or the like. The particular themes discussed herein are provided by way of example only and should not be construed to limit the invention. Indeed, embodiments of the invention include configuration files 222 defining themes that are the same or different than the specific examples provided herein.

As already explained above, the configuration files 222 can include the configuration file 302 of FIG. 3A. One example of configuration file 302 implemented as an .swf file is disclosed in FIG. 3B. As shown in FIG. 3B, configuration file 302 defines a configuration interface 308 that allows a recipient to control certain aspects of a presentation as it is rendered to the recipient. For instance, the recipient can play, pause or stop a presentation using buttons 308A, 308B included in the configuration interface 308. Alternately or additionally, a recipient can jump to the next image or previous image in a sequence of images using buttons 308C, 308D. Other buttons 308E-308G included in the configuration interface 308 allow a recipient to control the volume of a presentation, download digital media included in the presentation, and/or print digital images from the presentation.

The configuration interface 308 further includes a dynamic presentation proxy 308H that operates in conjunction with a rendering application such as the rendering application 114 of FIG. 1 to dynamically render the presentation to a user. Dynamically rendering the presentation can include, among other things, simultaneously rendering an audio file of the presentation separately from a sequence of image files of the presentation such that a user can move forward and backward in the sequence of image files without interrupting rendition of the audio file. Accordingly, the image files are not tied in parallel to the audio file.

Dynamically rendering the presentation can alternately or additionally include selecting one or more rendition attributes of each image file in the sequence of image files on the fly such that the rendition attributes of each image file are not necessarily the same from one rendition of the image files to another. As used herein, “rendition attributes” include zoom attributes defining whether to zoom in or out on an image as it is displayed, pan attributes defining whether to pan right to left, left to right, top to bottom, or bottom to top as an image is displayed, or the like or any combination thereof. Thus, in some examples, the dynamic presentation proxy 308H might select to zoom in on a particular image during a first rendition of the image, while selecting to pan right to left on the same image during a subsequent rendition of the same image (e.g., in response to a user selecting the button 308D or during subsequent rendition of the presentation), or the like or any combination thereof.

As shown in FIG. 3B, the configuration file 302 further defines a background 310 that can be rendered along with the image files and/or other digital media included in the presentation. The background 310 provides at least part of the “look and feel” specific to the configuration file 302. Other aspects of the “look and feel” specific to and defined by the configuration file 302 can include the layout or appearance of the configuration interface 308, background 310 and a logo 312 relative to each other.

Alternately or additionally, the configuration file 302 can define one or more buttons 314, 316, 318 to render to a recipient before, during, or after rendition of the presentation. The buttons 314, 316, 318 can allow the recipient to share the presentation with one or more other users, replay the presentation, or create a new presentation.

In some embodiments, the use of configuration files 302 allows different creators to create different presentations that include the same configuration file 302 such that the different presentations will have the same theme or “look and feel” when rendered, despite the fact that the different presentations include different digital media. Further, the different digital media included in the different presentations can be identified in the corresponding presentation records 304 (FIG. 3A) of the different presentations. Thus, configuration file 302 is configured to dynamically assemble and render digital media identified by a corresponding presentation record 304 within the context of the theme defined by the configuration file 302.

As already explained above with respect to FIG. 3A, the presentation record 304 identifies whether certain presentation features are enabled or disabled for the presentation 300. The configuration file 302 turns the features on or off depending on whether the features are identified in the presentation record 304 as being enabled or disabled. For instance, depending on the enabled and disabled features identified in the presentation record 304, the configuration file 302 can turn on or off one or more of: a presentation title 308J displayed during rendition of the presentation, the button 308F that allows recipients to download images, the button 308G that allows recipients to print images, or the button 314 that allows recipients to share the presentation with other users.

One example of a user interface 320 generated by a rendering application 114 executing a configuration file 302 is disclosed in FIG. 3C. As shown in FIG. 3C, the user interface 320 includes a background 322, a media player interface 324, a logo 326 and a title 328. The background 322 of user interface 320 is rendered as defined by the background 310 of configuration file 302. Similarly, the media player interface 324, logo 326 and title 328 of user interface 320 are rendered as respectively defined by the configuration interface 308, logo 312 and presentation title 308J of configuration file 302. Within the media player interface 324, digital media included in the presentation 300, such as images or video, are rendered.

In some embodiments of the invention, the configuration file 302 includes instructions that cause the user interface 320 to be rendered differently depending on the client device 106 rendering the user interface 320. For instance, the user interface 320 may be rendered differently in a client device 106A comprising a personal computer than in a client device 106C comprising a mobile telephone. In more detail, the configuration file 302 may include instructions that resize elements of the user interface 320 to be smaller, that arrange elements of the user interface 320 differently for rendition in the client device 106C as compared to rendition in the client device 106A, or that otherwise adapt rendition of the presentation 300 for the specific client device 106 rendering the presentation 300.

As already explained above, the configuration file 302 defines a particular layout. For instance, the layout can include the positions of the media player interface 324 and/or logo 326 within user interface 320. The layout can be altered by the configuration file 302 in the event the user interface 320 is resized. For instance, if a window in which the user interface 320 is rendered is resized to be smaller (e.g., by a recipient), the configuration file 302 can reposition the logo 326 closer to the media player interface 324.

Alternately or additionally, the configuration file 302 can define certain constraints for the elements of user interface 320. For instance, the configuration file 302 can constrain the logo 326 to a single position relative the media player interface 324. Alternately or additionally, the configuration file 302 can allow the logo 326 to be repositioned when a window in which the user interface 320 is rendered is resized so long as repositioning the logo 326 does not result in the logo being repositioned over the media player interface 324 and/or title 328.

In some embodiments, the configuration file 302 identifies an environment on the client device 106 in which the presentation is being rendered. The identified environment comprises, for instance, a browser, operating system, client device 106, or the like. The configuration file 302 may include instructions that change aspects of the user interface 320 depending on the identified environment. For instance, if the configuration file 302 identifies that the presentation is being rendered on a mobile telephone client device 106C, or other client device 106 incapable of printing, the configuration file 302 can disable or turn off the print button 308G, even though the print button 308G may have been enabled by the creator of the slideshow 300.

B. Upload Scripts

Returning to FIGS. 1 and 2, the upload scripts 224 are configured to receive digital media uploaded by a user via the upload application 210 executing on a client device 106 and then save the digital media to the media server 110. Alternately or additionally, the upload scripts 224 provide received digital media to the media processing module 212 for processing prior to saving the digital media to the media server 110. Although not required, in some embodiments the upload scripts 224 comprise multiple scripts that are each configured to receive a different type of digital media. For instance, one upload script 224 may be configured to receive .jpg or other digital image files, while another upload script 224 is configured to receive .mp3 or other digital audio files, and yet another upload script 224 is configured to receive .mpeg or other digital video files.

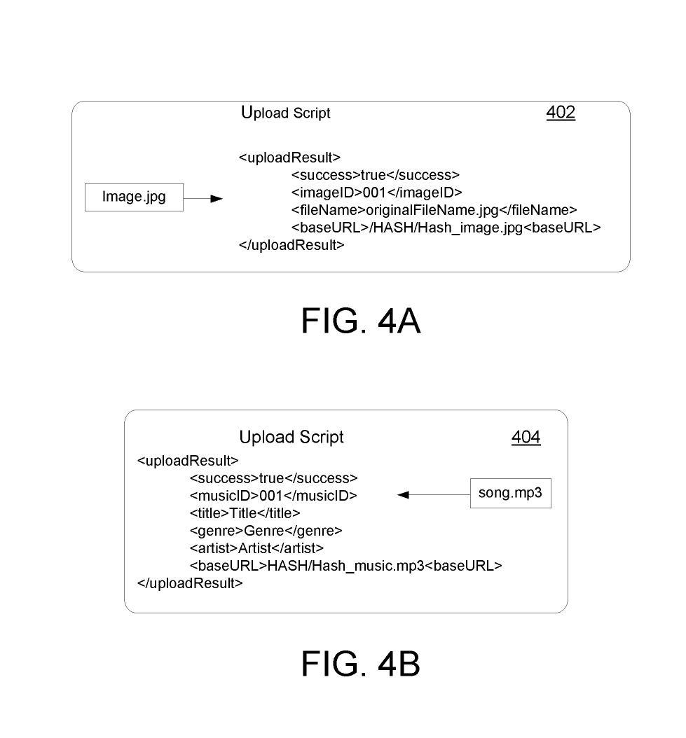

In more detail, FIGS. 4A and 4B disclose two example upload scripts 302, 304 that may correspond to the upload scripts 224 of FIG. 2 and that are configured to receive digital media files. More particularly, with combined reference to FIGS. 1-4B, the upload scripts 402, 404 can be implemented to receive, respectively, digital image files and digital audio files from an upload application 210 executing on a client device 106. Alternately or additionally, upload scripts 402, 404 can be configured to receive or extract metadata associated with the received digital media files and to save the metadata in a user account 220 associated with the user that uploaded the digital media files. The metadata may comprise one or more of a unique identifier, a file name, a pointer to the digital media file, a title/genre/artist associated with the digital media file, or the like or any combination thereof. Such metadata can be provided by the user via the upload application 210 and received by the upload script 402, 404, extracted by the upload script 402, 404, or any combination thereof. For instance, in the example of an .mp3 audio file comprising a song, the user can input the title, genre and artist of the song, and/or the upload script 404 can extract the title, genre and artist of the song from an id3 tag included in the .mp3 audio file.

C. Service File

Returning to FIGS. 1 and 2, the service file 226 includes definitions of services that are called by the upload application 210 and/or builder application 214 when the applications 210, 214 are being executed on a client device 106. Calling the services of service file 226 allows data at the applications 210, 214 to be synced with data at the application server 108. More particularly, execution of the upload application 210 and/or builder application 214 by a client device 106 can cause the client device 106 to communicate with the service file 226 to call one or more of the services defined in the service file 226. In response, the service file 226 identifies and returns particular data associated with the service call or causes the application server 108 to perform a particular action associated with the service call. In some embodiments, the particular data returned to the client device 106 in response to a service call comprises a VO, although use of VOs is not required in all embodiments.

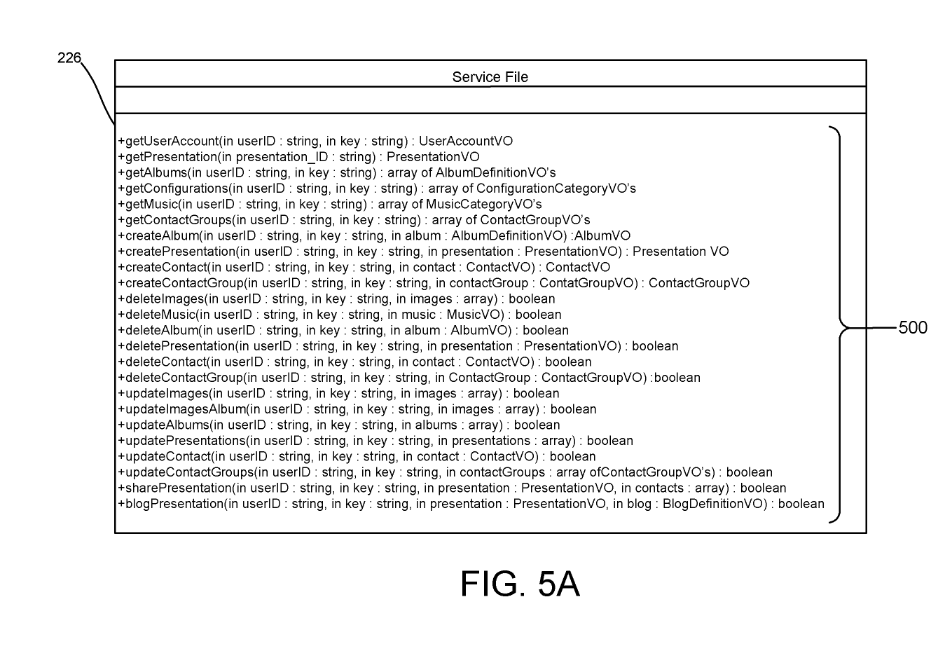

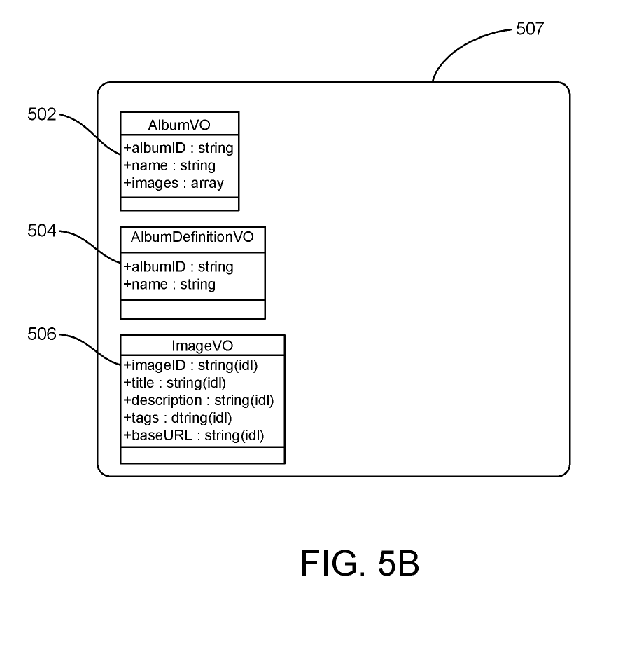

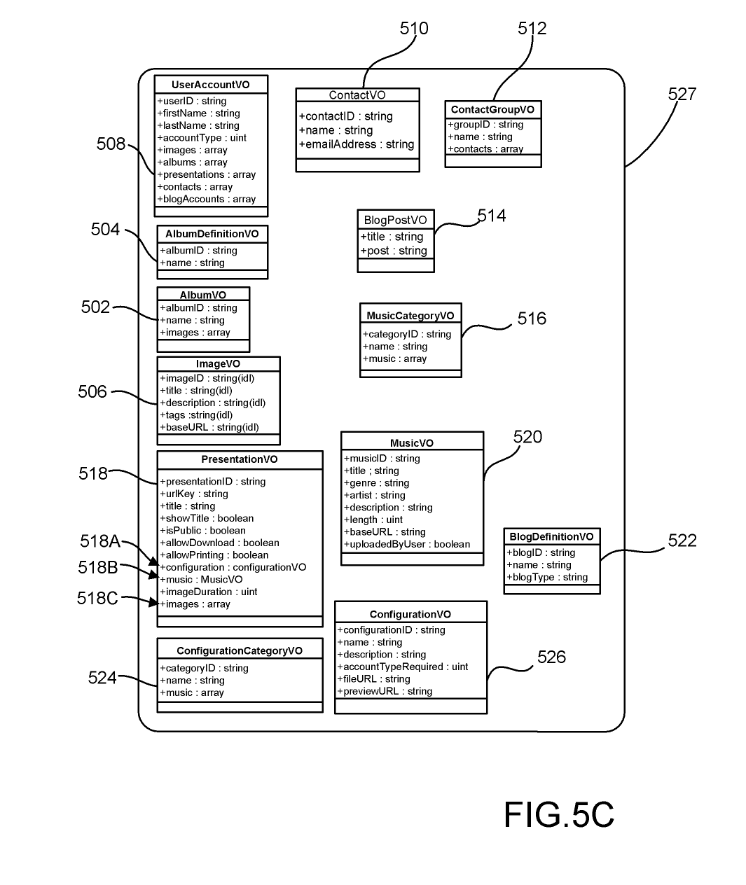

With additional reference to FIGS. 5A-5C, examples of a service file 226 and VOs that can be implemented in conjunction with the service file 226 according to some embodiments of the invention are disclosed. More particularly, FIG. 5A discloses an example implementation of service file 226, FIG. 5B discloses examples of various VOs that the service file 226 can return to the upload application 210, and FIG. 5C discloses examples of various VOs that the service file 226 can return to the builder application 214. It is understood that the service file 226 and VOs disclosed in FIGS. 5A-5C are not intended to be exhaustive or limiting of the service files and/or VOs that can be employed according to embodiments of the invention, nor are services files 226 and VOs required in all embodiments of the invention.

As shown in FIG. 5A, the service file 226 comprises a plurality of service definitions 500. Generally, each service definition 500 is structured as: service (input): output. Accordingly, in operation, an upload application 210 or builder application 214 can make a service call to the service file 226 by specifying a service and providing the required input. In response, the service file 226 returns the output associated with the specified service to the corresponding application 210, 214 and/or causes the application server 108 to perform a particular action associated with the specified service.

Each service identified in service definitions 500 is briefly described below. However, the number, names and functions of the services included in the service definitions 500 of service file 226 are provided by way of example only and should not be construed to limit the invention. For instance, embodiments of the invention include service files having different numbers of services and/or services with different names or functions than are disclosed herein.

The getUserAccount service is called from the builder application 210 to retrieve account information associated with a particular user. The account information can be received in the form of a UserAccountVO (see FIG. 5B) that identifies, among other things, the location of digital media associated with the user. The builder application 210 uses the information from the UserAccountVO to retrieve thumbnails of the digital media and/or the original digital media from the media server 110. In some embodiments, the input associated with this and other services includes a userID, which can be received during a login process for the user, or the like.

The getPresentation service is called from a configuration file 222 executing in a rendering application 114 of a client device 106. The getPresentation service returns a presentation record, such as the presentation record 304 of FIG. 3. Alternately or additionally, the presentation record is in the form of a PresentationVO (see FIG. 5C).

The getAlbums service is called from the upload application 210. The getAlbums service returns a list of the names of albums created by the user.

The getConfigurations service is called from the builder application 214. The getConfigurations service returns a list of configuration files 222.

The getMusic service is called from the builder application 214. The getMusic service returns a list of audio files available for inclusion in a presentation.

The getContactGroups service is called from the builder application 214. The getContactGroups service returns a list of contact groups created by the user and/or contact data for the user's contacts.

The createAlbum service is called from the builder application 214 and/or the upload application 210. The createAlbum service instructs the application server 108 to create a new album record in the corresponding user account 220.

The createPresentation service is called from the builder application 214. The createPresentation service instructs the application server 108 to create a new presentation record in the corresponding user account 220.

The createContact service is called from the builder application 214. The createContact service instructs the application server 108 to create a new contact record in the corresponding user account 220.

The createContactGroup service is called from the builder application 214. The createContactGroup service instructs the application server 108 to create a new contact group record in the corresponding user account 220.

The deleteImages service is called from the builder application 214 and/or the upload application 210. The deleteImages service passes in a list of images to the application server 108 and instructs the application server 108 to delete any metadata associated with the images from the corresponding user account 220 and to delete the images from the media server 110.

The deleteMusic service is called from the builder application 214. The deleteMusic service instructs the application server 108 to delete any metadata associated with particular audio file(s) uploaded by the user from the corresponding user account 220 and to delete the audio file(s) from the media server 110.

The deleteAlbum service is called from the builder application 214. The deleteAlbum service instructs the application server 108 to remove the corresponding album record from the corresponding user account 220.

The deletePresentation service is called from the builder application 214. The deletePresentation service instructs the application server 108 to remove the corresponding presentation record from the corresponding user account 220.

The deleteContact service is called from the builder application 214. The deleteContact service instructs the application server 108 to remove the corresponding contact record(s) from the corresponding user account 220.

The deleteContactGroup service is called from the builder application 214. The deleteContactGroup service instructs the application server 108 to remove the corresponding contact group record(s) from the corresponding user account 220.

The updateImages service is called from the builder application 214 and/or the upload application 210. The updateImages service instructs the application server 108 to update metadata for a list of image objects passed in with the updateImages service call.

The updateImagesAlbum service is called from the upload application 210. The uploadImagesAlbum service comprises a utility method that allows the application server 108 to update a single album that one or more images are associated with. In particular, the builder application 214 allows a single image to be stored in multiple albums. The updateImagesAlbum service associates an image with a single album and removes associations with other albums, if any.

The updateAlbums service is called from the builder application 214. The updateAlbums service instructs the application server 108 to add and remove references to one or more images in the album.

The updatePresentations service is called from the builder application 214. The updatePresentations service instructs the application server 108 to update one or more aspects of a presentation, including one or more of a configuration file, audio file, and/or image file(s) included in the presentation.

The updateContact service is called from the builder application 214. The updateContact service updates contact data in the corresponding user account 220.

The updateContactGroups service is called from the builder application 214. The updateContactGroups service updates contact group information in the corresponding user account 220, such as when contacts are added to or removed from the contact group.

The sharePresentation service is called from the builder application 214. The sharePresentation service instructs the application server 108 to generate and send an electronic message containing a link to a corresponding presentation to one or more contacts passed to the application server 108 with the sharePresentation service call.

The blogPresentation service is called from the builder application 214. The blogPresentation service instructs the application server 108 to create a new post with a link to a corresponding presentation on a blog identified by the creator of a presentation.

In some instances, the service file 226 exchanges data with the client device 106 in the form of a VO or other record during or in response to receiving a service call from the client device 106. Examples of various records 502, 504, 506 (collectively referred to herein as “records 507”) that can be exchanged between the upload application 210 and service file 226 according to some embodiments of the invention are disclosed in FIG. 5B. Examples of various records 502, 504, 506, 508, 510, 512, 514, 516, 518, 520, 522, 524, 526 (collectively referred to herein as “records 527”) that can be exchanged between the builder application 214 and service file 226 according to some embodiments of the invention are disclosed in FIG. 5C. The records 507, 527 are provided by way of example only and should not be construed to limit the invention.

With combined reference to FIGS. 5B and 5C, record 502 comprises a record of an album created by a user. The album record 502 can comprise an AlbumVO that includes an array of one or more images. The images array included in the record 502 contains a plurality of image records 506 comprising imageVOs in some embodiments.

Record 504 includes a list of names of one or more albums created by a user. The record 504 can comprise an AlbumDefinitionVO.

Image record 506 comprises a record of an image. The image record 506 can comprise an ImageVO that includes a baseURL. The baseURL can include a hash value or other pointer to the corresponding image. Accordingly, each image uploaded by a user to the content sharing system 104 can include an associated image record 506 comprising an ImageVO stored in the corresponding user account 220.

With continued reference to FIG. 5C, the user account record 508 includes data relating to a particular user account 220. A separate user account record 508 is created by the application server 108 for each user account 220. The user account record 508 can comprise a UserAccountVO. The user account record 508 can be sent to a client device 106 and can include all the data that is used to initialize the builder application 214 on the client device 106. The user account record 508 includes, in some embodiments, an accountType parameter that allows certain content, such as configuration files 222, to be made available to users on a subscription or pay basis. As such, the accountType parameter can be compared to an accountTypeRequired parameter of a configuration file 222 or other content to determine whether the user is permitted to access the content.

The record 510 comprises a contact record, such as a ContactVO. A new contact record 510 is created each time the builder application 214 calls the createContact service of FIG. 5A.

The record 512 comprises a contact group record, such as a ContactGroupVO. A new contact group record 512 is created each time the builder application 214 calls the createContactGroup service.

The blog post record 514 defines a blog post that can be made to a blog identified in a corresponding blog definition record 522. The blog post record 514 can comprise a BlogPostVO.

The music category record 516 includes a list of categories of music. The music category record 516 can comprise a MusicCategoryVO.

The presentation record 518 comprises a record of a presentation, similar to the presentation record 304 of FIG. 3, and can comprise a PresentationVO. The application server 108 generates a presentation record 518 for each presentation created by a creator. Each presentation record 518 includes a unique identifier, designated presentationID in FIG. 5C. In some embodiments, the unique identifier of a presentation record 518 is generated by the application server 108 when a presentation is created and saved to the application server 108. Each presentation record 518 identifies all the digital media and/or other content making up a particular presentation. For instance, the presentation record 518 identifies a particular configuration file at 518A, a particular audio file at 518B, and one or more image file(s) at 518C that are included in a presentation. As explained earlier, the presentation record 518 can further identify whether one or more features are enabled or disabled for the presentation.

The music record 520 comprises a record of an audio file. The application server 108 generates an audio file record 520 for each audio file stored on the media server 110, whether uploaded by users or provided by an administrator of the content sharing system 104. Within each user account 220, however, music records 520 are stored for audio files uploaded by the corresponding user and/or for some or all of the audio files provided by an administrator. The music record 520 can include an uploadedByUser property that specifies whether or not the corresponding audio file was uploaded by the user.

The blog definition record 522 identifies a blog to which a presentation can be posted alone or in combination with a blog post defined by the blog post record 514. The blog definition record 522 can comprise a BlogDefinitionVO.

The record 524 comprises a configuration category record, such as a ConfigurationCategoryVO. In some embodiments, configuration files are organized into categories, each category being defined by a configuration category record 524, to simplify a user interface users access when searching for/selecting configuration files for inclusion in presentations. For instance, a “Special Events” category, a “Holiday” category, and/or other categories can be defined by corresponding configuration category records 524, with particular configuration files being accessible through corresponding categories of the user interface. In some embodiments, for example, a “Wedding” configuration file is accessible through the “Special Events” category of the user interface, while a “Christmas” configuration file is accessible through the “Holiday” category of the user interface. The specific examples described herein are provided by way of illustration only and should not be construed to limit the invention. For example, the same or other categories can alternately or additionally be implemented in conjunction with the same or different configuration files.

The configuration record 526 comprises a record of a corresponding configuration file 222. The configuration record 526 can comprise a ConfigurationVO.

### III. Example Methods of Operation

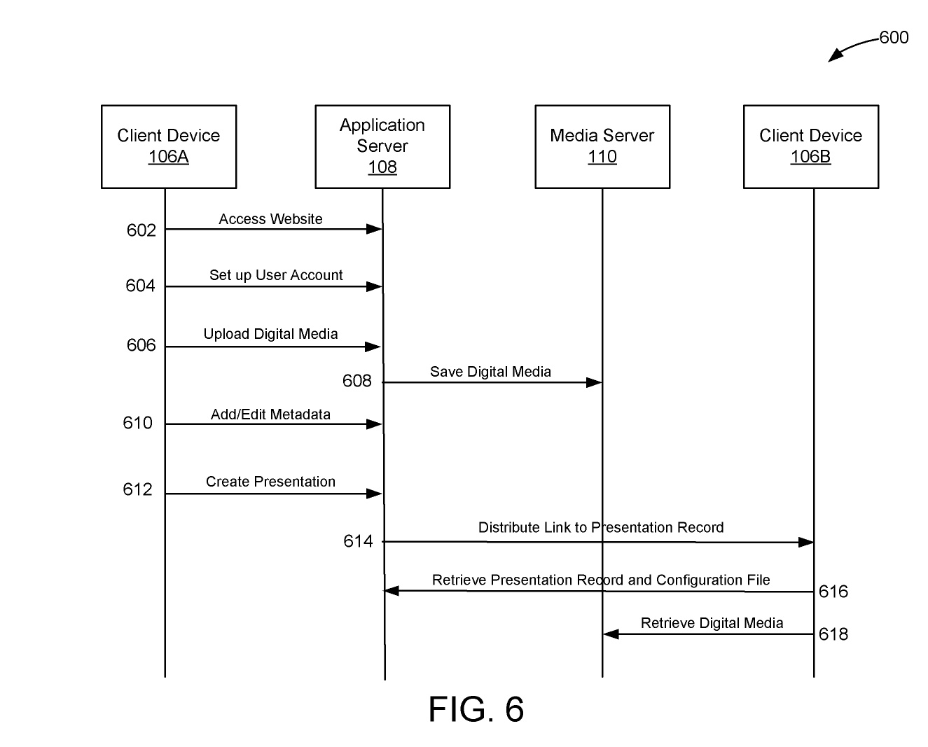

With additional reference to FIGS. 6-10, various example methods of operating the operating environment 100 of FIG. 1, or portions of the operating environment 100, are disclosed. For instance, FIG. 6 discloses one example of a process 600 for operating the operating environment 100.

The process 600 begins at step 602 when a creator accesses a website (e.g., web page files 208) hosted by application server 108 via a first client device 106. At 604, the creator sets up a user account 220 on the application server 108. At 606, the creator uploads digital media to the application server 108 for processing. At 608, the application server 108 saves the original digital media and/or any processed digital media to the media server 110. At 610, the creator adds or edits metadata associated with the digital media and uploads the metadata to the application server 108. At 612, the creator creates a presentation 300 (e.g., via builder application 214) and uploads it to the application server 108 and the application server 108 stores a corresponding presentation record 304 (or 518) in the creator's user account 220. At 614, the application server 108 distributes a link to the presentation record 304 (or 518) via electronic message, blog, social networking site, or the like. At 616, a second client device 106 accesses the link to retrieve the presentation record 304 (or 518) and an associated configuration file 302 from the application server 108. At 618, the second client retrieves the digital media 306 identified in the presentation record 304 (or 518) from the media server 110 and renders the presentation 300 to a recipient.

It will be appreciated by those of skill in the art that the process 600 of FIG. 6 described above is provided by way of illustration and not by way of limitation. Further, the steps of FIG. 6 can be rearranged in order and combined or eliminated or other steps may be added due to design considerations depending on the implementation of the operating environment 100. Alternately or additionally, in some embodiments, the presentation 300 can be created at step 612 and rendered at step 618 by the same client device 106 or different client devices 106.

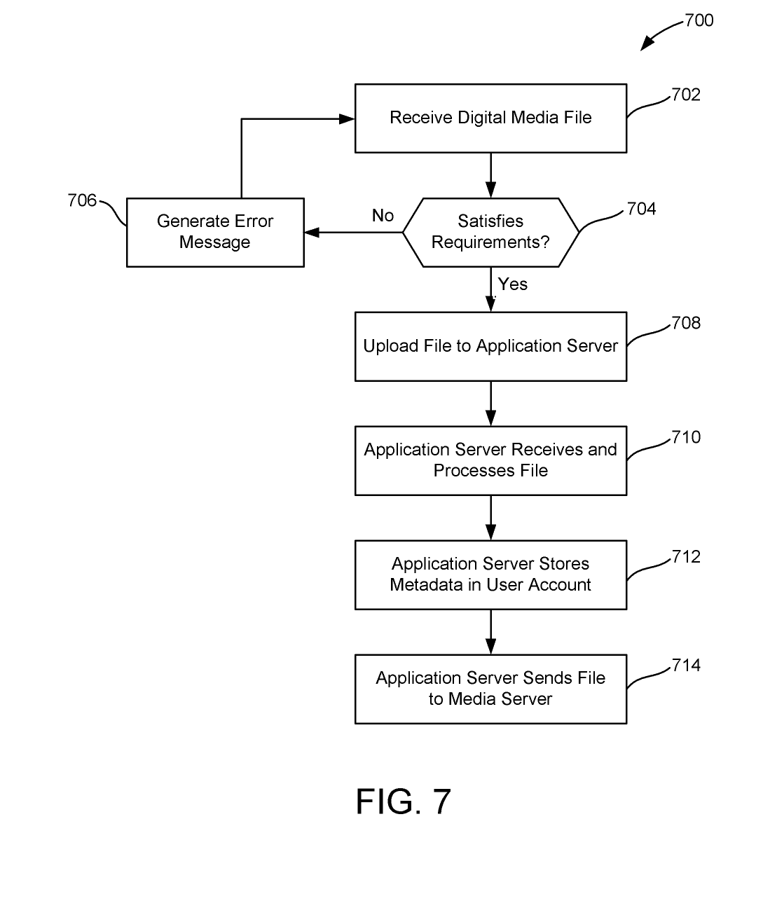

FIG. 7 discloses one example of a method 700 of uploading digital media from a client device 106 to the application server 108 of FIG. 1. In some embodiments, the method 700 corresponds to one or more of the steps of FIG. 6, such as steps 606 and 608. Furthermore, the method 700 is performed in some embodiments by an upload application 210 executing on a client device 106 and one or more of the upload scripts 224, media processing module 212 or media archive module 218 executing on the application server 108 of FIG. 2.

The method 700 of FIG. 7 begins at 702 when the upload application 210 executing on client device 106 receives a digital media file that a user desires to upload. At decision step 704, the upload application 210 determines whether the digital media file satisfies one or more system requirements, such as format compatibility and/or a file size limitation. For instance, the application server 108 and its components may be incompatible with and unable to process certain types of digital media. Alternately or additionally, the application server 108 may impose maximum file size limitations on uploaded digital media files.

If the digital media file does not satisfy the system requirements, at step 706 the upload application 210 generates an error message for the user and waits to receive another digital media file from the user at step 702. On the other hand, if the digital media file satisfies the system requirements, at step 708 the upload application 210 uploads the digital media file to the application server 108.

At step 710, the application server 108 receives and processes the digital media file. Processing the digital media at step 710 can include, among other things, generating a thumbnail image of the digital media (in the case of an image file) and/or generating a modified instance of the digital media based on one or more predetermined criteria associated with one or more configuration files. As explained above, the one or more predetermined criteria can include one or more of file size, color depth, cropping, aspect ratio, image size, compression ratio, or the like. Alternately or additionally, processing the digital media at step 710 can include generating, extracting or receiving metadata associated with the digital media, the metadata including one or more of a unique identifier, a title, a pointer to the digital media, a pointer to an associated thumbnail, a pointer to a modified instance of the digital media, a genre, an artist, a length, or the like.

At step 712, the application server 108 stores the digital media metadata in the corresponding user account 220 of database 228. At step 714, the application server 108 sends the digital media and any processed instances of the digital media to the media server 110 for storage.

It will be appreciated by those of skill in the art that the method 700 of FIG. 7 described above is provided by way of illustration and not by way of limitation. Further, the steps of FIG. 7 can be rearranged in order and combined or eliminated or other steps may be added due to design considerations depending on the implementation of the application server 108. In some instances, the method 700 can be repeated separately for each digital media file a user desires to upload. Alternately or additionally, the method 700 can be performed on a plurality of digital media files all at the same time.

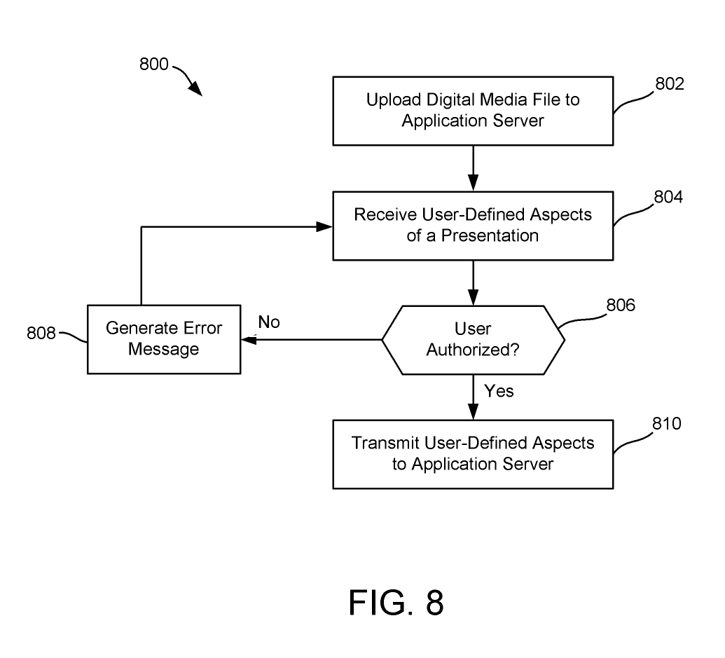

FIG. 8 discloses one example of a method 800 of creating a presentation 300. In some embodiments, the method 800 incorporates one or more of the steps of FIGS. 6 and 7. Furthermore, the method 800 is performed in some embodiments by a builder application 214 executing on a client device 106.

The method 800 begins at step 802 when the builder application 214 uploads a digital media file to the application server 108. The uploading of the digital media file at step 802 may be performed as explained above with respect to the method 700 of FIG. 7 in some embodiments.

At step 804, the builder application 214 receives user input defining aspects of a presentation 300, the user-defined aspects identifying a configuration file 222 and a plurality of digital media files 306 for inclusion in the presentation 300. In some embodiments, the identified digital media files 306 include at least one image file and at least one audio file. Alternately or additionally, the user-defined aspects received at step 804 identify one or more of: a title of the presentation 300, whether to display the title during rendition of the presentation 300, whether to allow recipients to share the presentation 300, whether to allow recipients to download digital media 306 included in the presentation 300, whether to allow recipients to print digital media 306 included in the presentation 300, or a period of time to display each image file in a sequence of image files included in the presentation 300.

Alternately or additionally, the user-defined aspects include sharing instructions that specify distribution of the presentation 300. In some cases, sharing instructions specify distribution of the presentation 300 to one or more particular recipients, websites, or client devices. For example, the sharing instructions can specify distribution to a particular recipient via an electronic message, such as an email message, SMS text message, MMS message, or other electronic message sent to an address (e.g., email address, cell phone number, etc.) associated with the particular recipient. Alternately or additionally, the sharing instructions can specify distribution to a particular website, such as a blog or social networking page of a creator of the presentation 300. Alternately or additionally, the sharing instructions can specify distribution to a particular client device, such as the network-enabled digital picture frame 106B. As such, the sharing instructions can include one or more recipient addresses (email address, cellular phone number, or the like), websites, or client device identifiers (serial number, MAC address, or the like) to which the presentation 300 is to be distributed.

In some embodiments, the user-defined aspects include selections by the creator If 5H Q of a particular configuration file, audio file and/or features from among a list of configuration files, audio files, and/or features. Accordingly, the method 800 can optionally include a decision step 806 where the builder application 214 determines whether the creator is authorized to use one or more particular selections included in the user-defined aspects. If the builder application 214 determines at step 806 that the creator is not authorized to use one or more particular selections included in the user-defined aspects, at step 808 the builder application 214 generates an error message for the creator and waits to receive revised user-defined aspects.

If the builder application 214 determines at step 806 that the creator is authorized to use one or more particular selections included in the user-defined aspects, the method 800 continues at step 810 where the builder application 214 transmits the user-defined aspects to the application server 108. Alternately or additionally, prior to transmitting the user-defined aspects to the application server 108 at step 810, the builder application 214 can generate a presentation record 304 (or 518) that is used to transmit the user-defined aspects to the application server 108.

In some embodiments, transmitting the user-defined aspects to the application server 108 at step 810 comprises calling the createPresentation service (see FIG. 5A) from the application server 108. In response, the application server 108 stores a presentation record 304 (or 518), including the user-defined aspects, in the creator's user account 220. Alternately or additionally, the application server 108 can distribute a link to the presentation record 304 (or 518) after storing the presentation record 304 (or 518) in the creator's user account 220.

It will be appreciated by those of skill in the art that the method 800 of FIG. 8 described above is provided by way of illustration and not by way of limitation. Further, the steps of FIG. 8 can be rearranged in order and combined or eliminated or other steps may be added due to design considerations depending on the implementation of the builder application 214 and/or application server 108. In some embodiments, for instance, steps 806 and 808 can be eliminated.

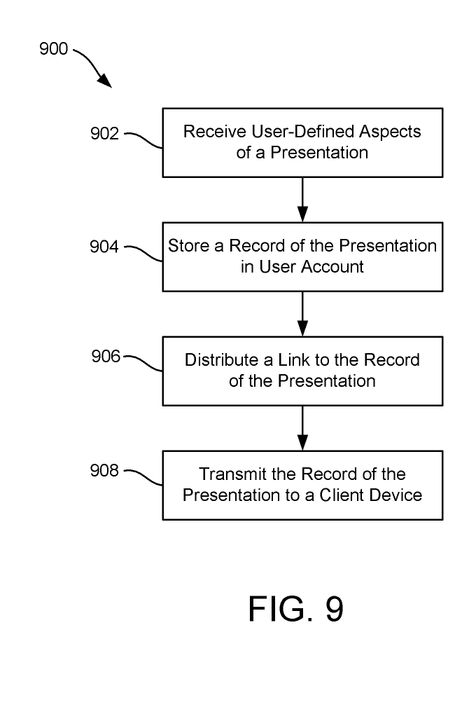

FIG. 9 discloses one example of a method 900 of sharing a presentation 300. In some embodiments, the method 900 corresponds to one or more of the steps of FIG. 6, such as steps 612, 614, 616. Furthermore, the method 900 is performed in some embodiments by the application server 108.

The method 900 begins at step 902 when the application server 108 receives user input defining aspects of a presentation 300, the user-defined aspects identifying a configuration file 302 and a plurality of digital media files 306 for inclusion in the presentation 300. An explanation of the user-defined aspects is provided in greater detail above with respect to FIG. 8. In some embodiments, receiving the user-defined aspects at step 902 comprises receiving a createPresentation service call (see FIG. 5A) from a builder application 214 executing on a client device 106.

As already explained above, the user-defined aspects received at step 902 can include sharing instructions that specify how to distribute the presentation 300. Further, the digital media 306 identified for inclusion in the presentation 300 at the client device 106 used to create the presentation 300 may be in a format that is incompatible with a particular client device to which the presentation 300 is to be distributed. For instance, a presentation 300 created at a client device 106A comprising a personal computer may include digital media 306 that is too large or otherwise incompatible with a client device 106C comprising a mobile telephone. As such, depending on the sharing instructions included in the user-defined aspects received at step 902, the method 900 can optionally include reformatting certain parameters of the presentation 300 to be compatible with a client device 106 to which the presentation 300 is distributed. The parameters modified by the application server 108 in such instances can include one or more of the presentation size, resolution, or the like.

At step 904, the application server 108 stores a presentation record 304 (or 518), including the user-defined aspects, in a user account 220 associated with a creator of the presentation 300. In some embodiments, the presentation record 304 (or 518) is generated by the builder application 214 as a package for transmitting the user-defined aspects to the application server 108. Alternately or additionally, the presentation record 304 (or 518) can be generated by the application server 108 after receiving the user-defined aspects from the builder application 214. Alternately or additionally, at step 904, the application server 108 additionally generates a unique identifier associated with the presentation 300 and stores it with the presentation record 304 (or 518).

Returning to FIG. 9, at step 906, the application server 108 distributes a link to the presentation record 304 (or 518) according to the user-defined aspects. As explained above, for example, the user-defined aspects can include sharing instructions that specify distribution to one or more particular recipients, websites, or client devices. As such, the link can be distributed in a number of ways. For instance, the application server 108 can generate an electronic message that includes an embedded URL or other link associated with the presentation record 304 (or 518) and that can be accessed by the client device 106. Alternately or additionally, the application server 108 can post a URL or other link associated with the presentation record 304 (or 518) to a blog associated with the creator and that can be accessed via the client device 106. Alternately or additionally, the application server 108 can post a URL or other link associated with the presentation record 304 (or 518) to a social network page of the creator within a social networking site, such as Facebook, MySpace, or the like. Alternately or additionally, the application server 108 can push the unique identifier associated with the presentation 300 to a particular client device 106B or transmit the unique identifier to the particular client device 106B in response to receiving a request from the client device 106B.

In some embodiments, the link distributed by the application server 108 includes a pointer such as a hash value that points to the presentation record 304 (or 518). Accordingly, in response to a client device 106 accessing the link, the application server 108 identifies the corresponding presentation record 304 (or 518) in the creator's user account 220 using the pointer included in the link and transmits the presentation record 304 (or 518) to the client device 106 at step 908. The link can be accessed to retrieve and dynamically render the presentation.

Alternately or additionally, after identifying the presentation record 304 (or 518) in the creator's user account 220 and prior to transmitting the presentation record 304 (or 518) to the client device 106 at step 908, the application server 108 identifies a particular configuration file 302 specified in the presentation record 304 (or 518) and transmits the configuration file 302 with an embedded unique identifier associated with the presentation record 304 (or 518) to the client device 106. In this and other embodiments, a rendering application 114 on the client device 106 executes the configuration file 302 to request the presentation record 304 (or 518) associated with the unique identifier, whereupon the application server 108 transmits the presentation record 304 (or 518) to the client device 106 at step 908.

It will be appreciated by those of skill in the art that the method 900 of FIG. 9 described above is provided by way of illustration and not by way of limitation. Further, the steps of FIG. 9 can be rearranged in order and combined or eliminated or other steps may be added due to design considerations depending on the implementation of the application server 108. In some embodiments, for instance, the method 900 can further include receiving digital media from the same client device 106 from which the user-defined aspects are received, processing the received digital media, and/or saving the received digital media or the processed digital media to the media server 110.

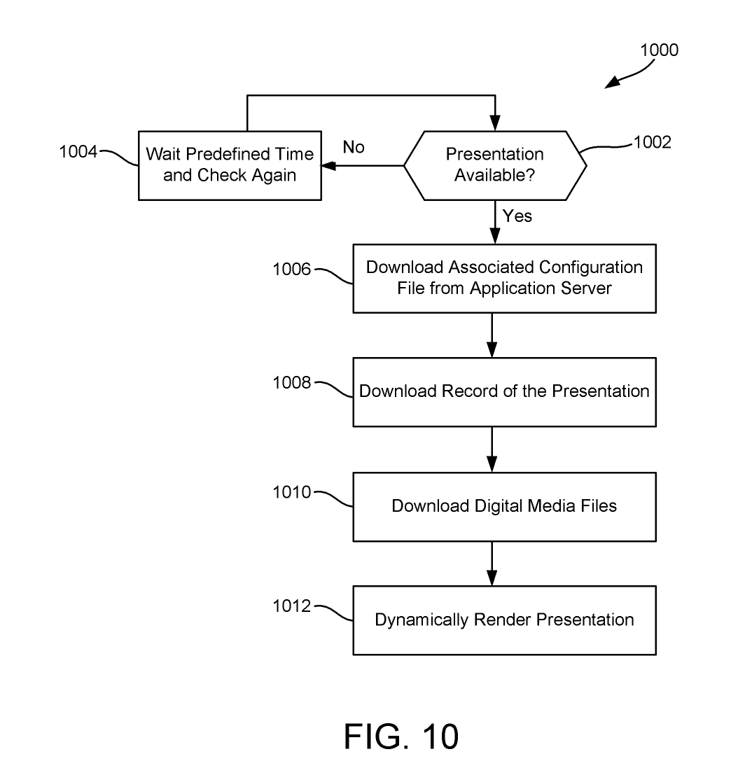

FIG. 10 discloses one example of a method 1000 of rendering a presentation 300 on a client device. In some embodiments, the method 1000 corresponds to one or more of the steps of FIG. 6, such as steps 614, 616, 618. Furthermore, the method 1000 is performed in some embodiments by a rendering application 114 on a client device 106B comprising a network-enabled digital picture frame.

The method 1000 can begin at decision step 1002 where the client device 106B determines whether a presentation 300 is available to the client device 106B. Determining whether the presentation 300 is available at step 1002 can include transmitting an identifier (such as a serial number, MAC address, or the like) associated with the client device 106B to the application server 108 such that the application server can check the database 228 for the existence of any presentations 300 that are available to the client device 106B using the identifier, and receiving a response from the application server 108 indicating whether a presentation 300 is available to the client device 106B. When a presentation 300 is available to the client device 106B, the response from the application server 108 can include a link to the corresponding presentation record 304 (or 518).

When the client device 106B determines that a presentation 300 is not available at step 1002, the method 1000 proceeds to step 1004 where the client device 106B waits a predefined period of time before returning to step 1002.

On the other hand, when the client device 106B determines that a presentation 300 is available at step 1002, the method 1000 proceeds to step 1006, where the client device 106B downloads a configuration file 302 associated with the presentation 300 from the application server 108, the configuration file 302 including a unique identifier associated with the presentation 300. In some instances, when the client device 106B receives a response from the application server 108 at step 1002 that includes a link to the presentation record 304 (or 518), step 1006 includes accessing the link such that the application server 108 uses the link to identify the presentation record 304 (or 518) to identify the corresponding configuration file 302 and associated unique identifier, and then transmits the configuration file 302 and associated unique identifier to the client device 106B.

At step 1008, the client device 106B downloads the presentation record 304 (or 518) from the application server 108 using the associated unique identifier. At step 1010, the client device 106B downloads a plurality of digital media files 306 identified in the presentation record 304 (or 518) from the media server 110. At step 1012, the client device 106B dynamically renders the presentation 300 according to user-defined aspects included in the presentation record 304 (or 518).

In some embodiments, the client device 106B performs each of steps 1002, 1004, 1006, 1008, 1010, 1012 automatically. Alternately or additionally, one or more of steps 1002, 1004, 1006, 1008, 1010, 1012 can be performed in response to user input. For instance, prior to the client device 106B dynamically rendering the presentation 300 at step 1012, the client device 106B may render a notification that a presentation 300 is available and wait to dynamically render the presentation 300 until after receiving user input to proceed. Alternately or additionally, the client device 106B may render a notification that a presentation 300 is available after determining that the presentation 300 is available at step 1002 and then wait for user input to proceed prior to performing one or more of steps 1006, 1008, 1010.

In some embodiments, a plurality of client devices 106B can be associated with the same client device identifier. In this case, each of the plurality of client devices 106B can separately perform the method 1000 of FIG. 10 to download the same presentation 300 in a substantially simultaneous manner. Such an embodiment might be used by a business having multiple locations with multiple client devices 106B or a single location with multiple client devices 106B to display identical and up-to-date presentations comprising deals, promotions or other information on all of the client devices 106B.

It will be appreciated by those of skill in the art that the method 1000 of FIG. 10 described above is provided by way of illustration and not by way of limitation. Further, the steps of FIG. 10 can be rearranged in order and combined or eliminated or other steps may be added due to design considerations depending on the implementation of the client device 106 that performs the method 1000. In some embodiments, for instance, some client devices 106 eliminate steps 1002 and 1004 and add a step of receiving a link to the presentation record 304 (or 518) prior to step 1006.

### IV. Computing Environment

The embodiments described herein may include the use of a special purpose or general purpose computer including various computer hardware and/or software modules, as discussed in greater detail below.

Embodiments within the scope of the present invention may also include physical computer-readable media and/or intangible computer-readable media for carrying or having computer-executable instructions or data structures stored thereon. Such physical computer-readable media and/or intangible computer-readable media can be any available media that can be accessed by a general purpose or special purpose computer. By way of example, and not limitation, such physical computer-readable media can comprise RAM, ROM, EEPROM, CD-ROM or other optical disk storage, magnetic disk storage or other magnetic storage devices, or any other physical medium which can be used to carry or store desired program code means in the form of computer-executable instructions or data structures and which can be accessed by a general purpose or special purpose computer. Within a general purpose or special purpose computer, intangible computer-readable media can include electromagnetic means for conveying a data signal from one part of the computer to another, such as through circuitry residing in the computer.

When information is transferred or provided over a network or another communications connection (either hardwired, wireless, or a combination of hardwired or wireless) to a computer, hardwired devices for sending and receiving computer-executable instructions, data structures, and/or data signals (e.g., wires, cables, optical fibers, electronic circuitry, chemical, and the like) should properly be viewed as physical computer-readable mediums while wireless carriers or wireless mediums for sending and/or receiving computer-executable instructions, data structures, and/or data signals (e.g., radio communications, satellite communications, infrared communications, and the like) should properly be viewed as intangible computer-readable mediums. Combinations of the above should also be included within the scope of computer-readable media.

Computer-executable instructions comprise, for example, instructions, data, and/or data signals which cause a general purpose computer, special purpose computer, or special purpose processing device to perform a certain function or group of functions. Although not required, aspects of the invention have been described herein in the general context of computer-executable instructions, such as program modules, being executed by computers, in network environments and/or non-network environments. Generally, program modules include routings, programs, objects, components, and content structures that perform particular tasks or implement particular abstract content types. Computer-executable instructions, associated content structures, and program modules represent examples of program code for executing aspects of the methods disclosed herein.

Embodiments may also include computer program products for use in the systems of the present invention, the computer program product having a physical computer-readable medium having computer-readable program code stored thereon, the computer-readable program code comprising computer-executable instructions that, when executed by a processor, cause the system to perform the methods of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for creating a presentation, the method comprising:
uploading a plurality of digital media files from a client device to an application server for processing and subsequent storage on a media server;
receiving user input from the client device defining aspects of a presentation, the user-defined aspects identifying a configuration file and a plurality of digital media files for inclusion in the presentation; and
transmitting the user-defined aspects from the client device to the application server, wherein the application server stores a record of the presentation, the record including the user-defined aspects, and wherein the application server distributes a link to the record that is accessed to retrieve and dynamically render the presentation.

2. The method of claim 1, further comprising:
receiving the link to the record from the application server at the client device;
accessing the link to download the record from the application server to the client device;
retrieving the digital media files identified by the user-defined aspects from the media server using the record; and
dynamically rendering the presentation on the client device according to the user-defined aspects.

3. The method of claim 2, wherein the digital media files identified by the user-defined aspects include an audio file and a sequence of image files, and wherein dynamically rendering the presentation on the client device comprises simultaneously rendering the audio file separately from the sequence of image files such that a recipient of the presentation can move forward and backward in the sequence of image files without interrupting rendition of the audio file.

4. The method of claim 2, wherein the digital media files identified by the user-defined aspects include a plurality of image files, and wherein dynamically rendering the presentation on the client device comprises selecting one or more rendition attributes of each image file on the fly such that the one or more rendition attributes of each image file differ from one rendition of the image files to another.

5. The method of claim 6, wherein the user-defined aspects of the presentation further identify one or more of: a title of the presentation; whether to display the title during rendition of the presentation; whether to allow recipients of the presentation to share the presentation; whether to allow recipients of the presentation to download the one or more digital media files; whether to allow recipients of the presentation to print the one or more digital media files; or a period of time to display each image file in a sequence of image files included in the presentation.

6. The method of claim 1, wherein the user-defined aspects include a selection by a creator of the presentation of one or more of a configuration file, audio file, or feature, the method further comprising, determining that the creator is authorized to make the selection prior to transmitting the user-defined aspects to the application server.

7. A method for sharing a presentation, the method comprising:
receiving user input at an application server from a first client device, the user input defining aspects of a presentation, the user-defined aspects identifying a configuration file and one or more digital media files to include in the presentation;
storing a record of the presentation on the application server, the record including the user-defined aspects;
distributing a link to the record; and
in response to a second client device accessing the link, transmitting the record to the second client device, wherein the second client device retrieves the one or more digital media files using the record and dynamically renders the presentation according to the user-defined aspects.

8. The method of claim 7, wherein the user-defined aspects of the presentation further identify one or more of: a title of the presentation; whether to display the title during rendition of the presentation; whether to allow recipients of the presentation to share the presentation; whether to allow recipients of the presentation to download the one or more digital media files; whether to allow recipients of the presentation to print the one or more digital media files; or a period of time to display each image file in a sequence of image files included in the presentation.

9. The method of claim 7, wherein: the first client device and the second client device are the same client device; or the first client device and the second client device are different client devices.

10. The method of claim 7, further comprising, prior to transmitting the record to the second client device, reformatting one or more parameters of the presentation to make the presentation compatible with the second client device.

11. The method of claim 7, further comprising:
receiving at least one of the one or more digital media files from the first client device;
processing the at least one of the one or more digital media files; and
saving the processed at least one of the one or more digital media files to a media server.

12. The method of claim 11, wherein processing the at least one of the one or more digital media files comprises altering one or more parameters of the at least one of the one or more digital media files.

13. The method of claim 12, wherein the one or more parameters include one or more of: a file size, image aspect ratio, image size, image cropping, image color depth, image resolution, file compression, vide stream length, or audio stream length of the at least one of the one or more digital media files.

14. The method of claim 7, further comprising, prior to transmitting the record to the second client device:
identifying the record in response to the second client device accessing the link, the link including a pointer to a unique identifier associated with the record;
transmitting the configuration file to the second client device, the configuration file having the unique identifier embedded therein; and
receiving a request for the record from the second client device, the request including the unique identifier.

15. The method of claim 7, wherein distributing a link to the record comprises one or more of: generating an electronic message that includes an embedded link associated with the record, the electronic message being accessible to the second client device; posting a link associated with the record to a website accessible to the second client device; or transmitting an identifier associated with the record to the second client device.

16. A method of rendering a presentation on a client device, comprising:
downloading a configuration file associated with a presentation from an application server, the configuration file including an identifier associated with the presentation;
downloading a record of the presentation from the application server using the presentation identifier, the record comprising a plurality of user-defined aspects, the plurality of user-defined aspects identifying a plurality of digital media files included in the presentation;
downloading the plurality of digital media files from a media server using the user-defined aspects; and
dynamically rendering the presentation according to the user-defined aspects.

17. The method of claim 16, wherein the digital media files include an audio file and a sequence of image files, and wherein dynamically rendering the presentation comprises simultaneously rendering the audio file separately from the sequence of image files such that a recipient of the presentation can move forward and backward in the sequence of image files without interrupting rendition of the audio file.

18. The method of claim 16, wherein the digital media files include a plurality of image files, and wherein dynamically rendering the presentation comprises selecting one or more rendition attributes of each image file on the fly such that the one or more rendition attributes of each image file differ from one rendition of the image files to another.

19. The method of claim 16, further comprising, prior to downloading the configuration file, determining that the presentation is available for rendition by the client device.

20. The method of claim 19, wherein determining that the presentation is available for rendition by the client device comprises:
transmitting an identifier associated with the client device to the application server, wherein the application server identifies a presentation associated with the client device identifier; and
the client device receiving a response from the application server, the response indicating that the presentation is available for rendition by the client device.

21. The method of claim 16, wherein the client device comprises a network-enabled digital picture frame or a mobile telephone.

22. An application server for creating and sharing a presentation, the application server comprising:
a computing device configured to execute computer-executable instructions;
a memory operably connected to the computing device, the memory comprising a tangible computer readable medium;
an upload application stored on the memory and configured to be transmitted to and executed by a first client device, the upload application comprising computer-executable instructions that, if executed by the first client device, cause the first client device to upload digital media files to the application server;
a media processing module stored on the memory and comprising computer-executable instructions that, if executed by the computing device, cause the computing device to process digital media files received from the first client device; and
a builder application stored on the memory and configured to be transmitted to and executed by the first client device, the builder application comprising computer-executable instructions that, if executed by the first client device, cause the first client device to create a presentation comprising a configuration file and one or more digital media files.

23. The application server of claim 22, further comprising a service file including definitions of services that are called by one or both of the upload application and the builder application when executing on the first client device, wherein the service file communicates with the upload application and builder application using value objects.
